(19) United States
(12) Patent Application Publication
(10) Pub. No.: US 2010/0323600 A1
(43) Pub. Date: Dec. 23, 2010

(54) CHAMBER FACILITY, ROBOT CELL INCLUDING CHAMBER FACILITY, AND CHAMBER VENTILATING METHOD

(75) Inventor: Shigeki TANAKA, Okaya (JP)

Correspondence Address: HARNESS, DICKEY & PIERCE, P.L.C., P.O. BOX 828, BLOOMFIELD HILLS, MI, 48303, US

(73) Assignee: SEIKO EPSON CORPORATION, Tokyo (JP)

(21) Appl. No.: 12/815,627

(22) Filed: Jun. 15, 2010

(30) Foreign Application Priority Data
Jun. 19, 2009 (JP) 2009-146053
Mar. 23, 2010 (JP) 2010-065803

(51) Int. Cl. B08B 15/02; F24F 7/00

(52) U.S. Cl. 454/66; 454/237

(57) ABSTRACT

A chamber facility includes: an air supply unit which supplies clean air to the inside of a chamber; an air supply port section which has one end communicating with the air supply unit and the other end opened into the chamber; and an air exhaust unit which exhausts air within the chamber from an exhaust port formed at a lower position of the chamber, wherein the air supply port section has a plurality of air supply port units which generate rotational flow around a vertical axis within the chamber.

### BACKGROUND

1. Technical Field

The present invention relates to a chamber facility which supplies clean air to a chamber while exhausting air from the chamber to maintain a predetermined degree of cleanliness of air within the chamber, a robot cell including the chamber facility, and a chamber ventilating method.

2. Related Art

A manufacturing device which includes an air supply unit for supplying clean air to a chamber from an upper position of the chamber, and an air exhaust unit which exhausts air from a lower position of the chamber is known (see JP-A-61-125121). This type of manufacturing device discharges dust produced during a manufacturing process toward below by using downflow of air.

According to this chamber, the air supply unit (fan filter unit) is disposed on a top wall area. Thus, other manufacturing device and the like cannot be equipped (suspended) on the top wall area. In this case, the entire area of the top wall cannot be used for other purpose, and thus other manufacturing device and the like cannot be positioned throughout the top wall area.

### SUMMARY

It is an advantage of some aspects of the invention to provide a chamber facility capable of efficiently discharging dust produced within a chamber while allowing other manufacturing device to be disposed on a top wall of the chamber, a robot cell including the chamber facility, and a chamber ventilating method.

A chamber facility according to a first aspect of the invention includes: an air supply unit which supplies clean air to the inside of a chamber; an air supply port section which has one end communicating with the air supply unit and the other end opened into the chamber; an air exhaust unit which exhausts air within the chamber from an exhaust port formed at a lower position of the chamber. The air supply port section has a plurality of air supply port units which generate rotational flow around a vertical axis within the chamber.

A chamber ventilating method which ventilates the inside of a chamber by supplying and exhausting clean air to and from the chamber according to a second aspect of the invention includes: generating rotational flow within the chamber by supplying the clean air from the side of the chamber while exhausting the air from a lower position of the chamber.

According to these structure and method, rotational flow around the vertical axis is generated within the chamber, and the air is exhausted from the lower position of the chamber. Thus, the air within the chamber moves downward while rotating around the vertical axis, thereby producing rotational downflow. As a result, the air flows throughout the chamber, and air staying space is reduced. In addition, dust generated within the chamber is removed toward below. Accordingly, a high degree of air cleanliness can be maintained within the chamber. Moreover, since the downflow can be produced by the structure not necessarily requiring the air supply port section on the top wall area (the ceiling area), an unoccupied space can be secured in the top wall area.

According to the chamber facility described above, it is preferable that each of the air supply port units includes an air manifold communicating with the air supply unit, and a plurality of blowoff ports communicating with the air manifold.

According to this structure, air can be uniformly blown off from the plural blowoff ports, and thus the rotational flow can be easily produced. In addition, the structure of the respective air supply port units can be simplified.

In this case, it is preferable that the air manifold extends in the vertical direction, and that the plural blowoff ports are disposed in line in the vertical direction along the air manifold.

The “in line” condition herein refers to a condition in which the blowoff ports are positioned in a line. It is more preferable that the blowoff ports are disposed at equal intervals since air can be uniformly blown off in the vertical direction.

According to this structure, the rotational flow can be generated throughout the area in the vertical direction by disposing the plural blowoff ports in line in the vertical direction. Thus, air staying space can be further reduced.

In this case, it is preferable that each of the blowoff ports can vary the direction of blowing off clean air.

According to this structure, the blowoff directions of the respective blowoff ports can be controlled. Thus, the rotational flow appropriate and suited for various requirements can be produced.

According to the chamber facility described above, it is preferable that each of the air supply port units includes an air manifold communicating with the air supply unit, and a slit-shaped blowoff port communicating with the air manifold.

According to this structure, each of the air supply port units has simplified structure requiring only the slit-shaped blowoff port. In addition, the rotational flow can be produced throughout the area in the vertical direction by using the blown off air.

In this case, it is preferable that the chamber has a rectangular parallelepiped shape, and that the plural air supply port units are at least the two air supply port units disposed at least at two diagonally positioned vertical corners included in four vertical corners formed by peripheral side walls of the chamber.

According to this structure, the respective air supply port units are disposed at the vertical corners formed by the peripheral side walls of the rectangular parallelepiped chamber. Thus, unoccupied space can be secured in the peripheral side wall area. Moreover, since air is blown off from the positions of the vertical corners where air easily stays, no air staying space is further produced. The portion “vertical corner” refers to a portion corresponding to a corner of the chamber in the plan view.

In this case, it is preferable that the air exhaust unit is disposed in a lower space immediately below a floor portion of the chamber and exhausts air within the chamber and within the lower space via an exhaust filter which removes a contaminant contained in the air.

According to this structure, air containing a contaminant (dust) within the chamber and the lower space can be cleaned by using the provided exhaust filter. Thus, clean air can be exhausted to the outside. Accordingly, the external atmosphere is not contaminated by the exhaust air from the chamber facility. In addition, air around the air exhaust unit where dust and the like are easily produced can be ventilated.

A chamber facility according to a fourth aspect of the invention includes: an air supply unit which supplies air to the inside of a chamber having a polygon pole shape surrounded by a top wall, a bottom wall, and a plurality of side walls; an air supply section which has one end communicating with the air supply unit and the other end communicating with the chamber room; and an air exhaust unit which exhausts air within the chamber from an exhaust port formed on the bottom wall of the chamber. The air supply section has air units which are disposed at least at two corners included in plural corners formed by the plural side walls of the chamber and which extend in the vertical direction. Each of the air units has a blowoff port whose blowoff direction shifts from a vertical axis of the chamber at an angle of larger than 0 degree.

The “polygon pole shape” herein refers to a rectangular parallelepiped shape (square pole shape), a triangle pole shape, a pentagon pole shape, a hexagon pole shape, or other polygon pole shapes.

According to this structure, each blowoff direction of the blowoff ports shifts from the vertical axis of the chamber at an angle of larger than 0 degree. Thus, rotational flow around the vertical axis can be produced within the chamber. Moreover, the air can be exhausted from the lower position of the chamber by using the air exhaust unit. In this case, the air within the chamber moves downward while rotating around the vertical axis, thereby producing rotational downflow. As a result, the air flows throughout the chamber, and air staying space is reduced. In addition, dust generated within the chamber is removed toward below. Accordingly, a high degree of air cleanliness can be maintained within the chamber.

Moreover, since the downflow can be produced by the structure not necessarily requiring the air supply port section on the top wall area (the ceiling area), an unoccupied space can be secured in the top wall area.

In this case, it is preferable that each of the air units has a plurality of blowoff ports, and that the plural blowoff ports are disposed in line at equal intervals in the vertical direction.

According to this structure, the rotational flow can be generated throughout the area in the vertical direction by disposing the plural blowoff ports in line in the vertical direction. Thus, air staying space can be further reduced.

Similarly, it is preferable that each of the air units has a slit-shaped blowoff port extending in the vertical direction.

According to this structure, each of the air supply port units has simplified structure requiring only the slit-shaped blowoff port. In addition, the rotational flow can be produced throughout the area in the vertical direction by using the blown off air.

### BRIEF DESCRIPTION OF THE DRAWINGS

The invention will be described with reference to the accompanying drawings, wherein like numbers reference to like elements.

FIG. 1 is a side view illustrating a robot cell according to an embodiment of the invention.

FIG. 2 schematically illustrates a pipe system of the robot cell.

FIGS. 3A and 3B are cross-sectional views illustrating horizontal air supply port units and vertical air supply port units, respectively.

FIG. 4 illustrates flow of air within the robot cell.

FIG. 5A schematically illustrates a modified example of the vertical air supply port unit.

FIG. 5B schematically illustrates the arrangement structure of the modified example shown in FIG. 5A.

### DESCRIPTION OF EXEMPLARY EMBODIMENT

A robot cell including a chamber facility according to an embodiment of the invention is hereinafter described with reference to the appended drawings. This robot cell accommodates a suspension type industrial robot and performs various processes for a workpiece within a work area contained in a chamber. The characteristic point of the robot cell is that appropriate flow of air can be efficiently produced within the chamber.

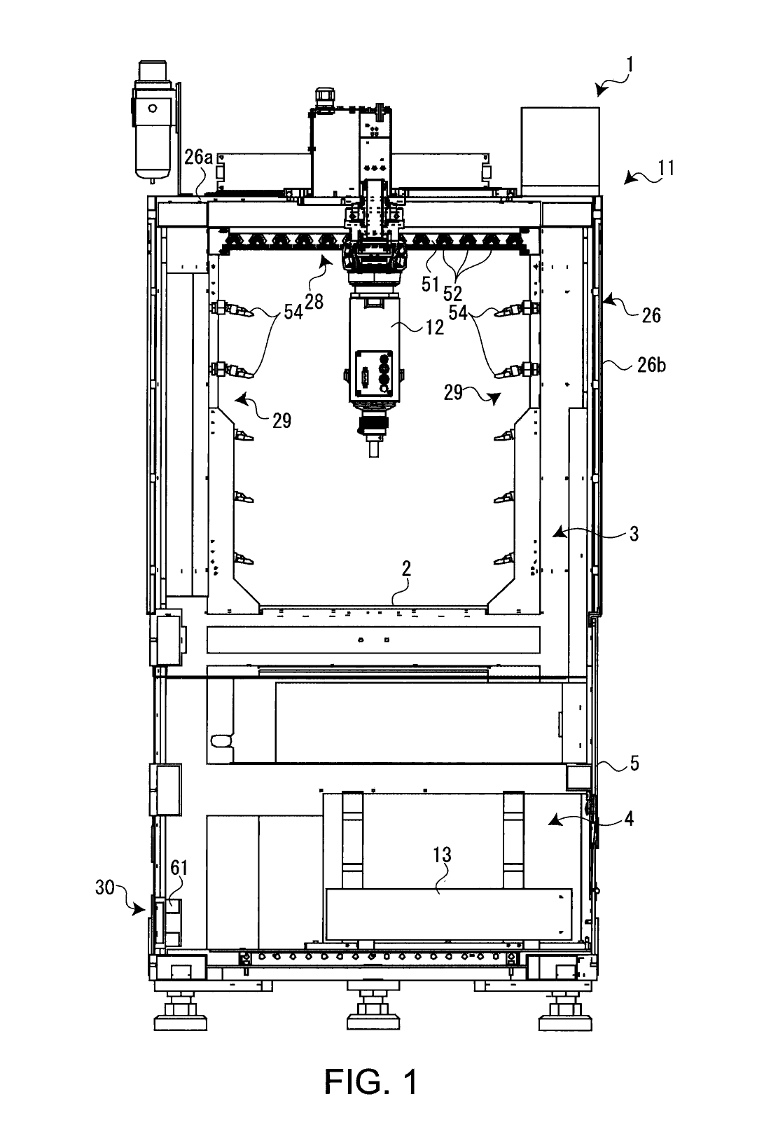

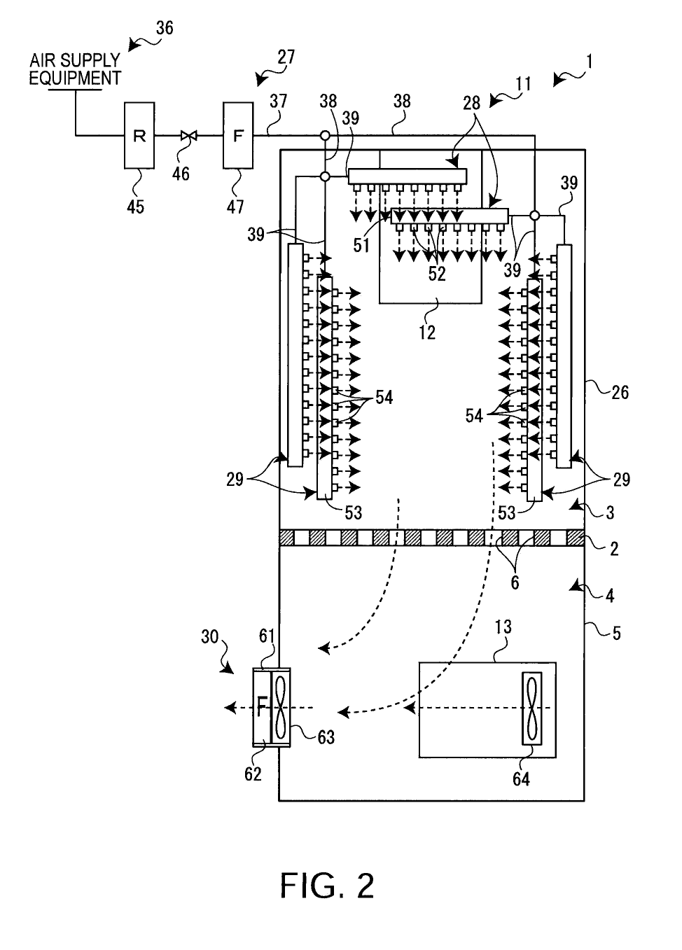

As illustrated in FIGS. 1 and 2, a robot cell 1 generally has a rectangular parallelepiped shape, and is divided into an upper space 3 and a lower space 4 by a support plate 2 disposed at an intermediate position in the up-down direction. The upper space 3 is surrounded by a chamber 26 and used as a work area of an industrial robot 12. The lower space 4 is surrounded by a lower external wall 5 and used as a storage area for storing a controller 13 described later and other components. The entire area of the robot cell 1 is closed by the chamber 26 and the lower external wall 5. A plurality of communicating holes 6 through which the upper space 3 and the lower space 4 communicate with each other are formed on the support plate 2. The respective quantities of air supplied to and exhausted from the robot cell 1 are controlled such that the internal pressure becomes positive with respect to the external pressure. The support plate 2 corresponds to the bottom of the chamber 26.

The robot cell 1 includes a chamber facility 11 which has the chamber 26 and maintains a predetermined degree of cleanliness of air within the chamber 26, the industrial robot (robot) 12 suspended from a top wall 26b of the chamber 26, and the controller 13 for controlling the chamber facility 11 and the industrial robot 12. The robot cell 1 further has various types of manufacturing equipment (including a palette or a work table on which a workpiece is placed) on the chamber 26 or the support plate 2 to function as a manufacturing device or assembling device of a workpiece.

The industrial robot 12 is a suspension type horizontal articulated robot (so-called scalar robot) which actuates an arm and an end effecter to perform various operations.

The chamber facility 11 includes the chamber 26 surrounding the upper space 3, an air supply mechanism (air supply section) 27 for supplying clean air to the inside of the chamber 26, two horizontal air supply port units 28 provided in the horizontal direction at the corners formed by the top wall 26a and four peripheral walls 26b of the chamber 26 (hereinafter referred to as horizontal corners), four vertical air supply port units 29 provided in the vertical direction at the corners formed by the four peripheral walls 26b of the chamber 26 (hereinafter referred to as vertical corners), and an air exhaust mechanism (air exhaust unit) 30 provided on the side walls of the lower external wall 5.

Clean air supplied from the air supply mechanism 27 is introduced through the respective horizontal air supply port units 28 and vertical air supply port units 29 into the chamber 26. The air within the chamber 26 is exhausted from the lower space 4 to the outside of the robot cell 1 by using the air exhaust mechanism 30. Air supply port units according to the appended claims correspond to the four vertical air supply port units 29.

The chamber 26 is produced by attaching the top wall 26a and the four peripheral walls (peripheral side walls) 26b to a rectangular parallelepiped frame body via seals. The four peripheral walls 26b have four side walls detachably attached to the frame body. The entire area of the chamber 26 except for the support plate 2 (floor wall) corresponding to the floor part of the chamber 26 is closed, and communicates with the lower space 4 positioned immediately below the floor part via the plural communicating holes 6 of the support plate 2.

The air supply mechanism 27 includes an air supply equipment 36 for supplying compressed air, a main flow path 37 whose upstream end is connected with the air supply equipment 36, two flow branches 38 branched from the main flow path 37 in two directions, and three individual flow paths 39 branched from each of the two flow branches 38 in three directions. The downstream ends of the three individual flow paths 39 of each of the two flow branches 38 are connected with the air supply port units 28 and 29 as different types of units. In this structure, the air supplied from the air supply equipment 36 is branched in six directions to be supplied to the two horizontal air supply port units 28 and the four vertical air supply port units 29.

A regulator 45, an opening and closing valve 46, and a filter 47 are provided on the main flow path 37 in this order from the air supply equipment 36. The regulator 45 controls the pressure of the supplied air based on a command issued from the controller 13. The filter 47 is a so-called HEPA filter (high efficiency particulate air filter) which cleans (removes contaminants from) the air supplied from the air supply equipment 36 to produce clean air. Thus, the air supplied from the air supply equipment 36 is introduced into the respective air supply port units 28 and 29 after pressure control by the regulator 45 and cleaning by the filter 47. An opening and closing valve connected with the controller 13 may be provided for each of the individual flow paths 39 such that air supply to the air supply port units 28 and 29 can be controlled individually.

As illustrated in FIGS. 1, 2 and 3A, each of the two horizontal air supply port units 28 is disposed at the two horizontal corners parallel with each other included in the four horizontal corners formed by the top wall 26a and the four peripheral walls 26b. That is, the two horizontal air supply port units 28 are located at the front and rear ends or the left and right ends of the top wall 26a. Each of the horizontal air supply port units 28 has a horizontal manifold 51 connected with the corresponding individual flow path 39, and a plurality of slit nozzles 52 communicating with the horizontal manifold 51. That is, one end (upstream end) of each of the horizontal air supply port units 28 communicates with the air supply mechanism 27, and the other end (downstream end) is opened into the chamber 26.

The horizontal manifold 51 is an air manifold extending in the horizontal direction along the horizontal corner. The plural slit nozzles 52 are provided in line in the extending direction of the horizontal manifold 51 (horizontal direction) in such a condition that each of the slit nozzles 52 communicates with the horizontal manifold 51. Each of the slit nozzles 52 has a slit-shaped blowoff port having a horizontal blowoff direction. That is, the respective slit nozzles 52 are provided in such a manner as to blow off a part of clean air toward the top surface (inner surface of the top wall 26a) of the chamber 26. The two horizontal air supply port units 28 are disposed opposingly each other, and the respective slit nozzles 52 of one of the two horizontal air supply port units 28 face the corresponding slit nozzles 52 of the other air supply port unit 28. Thus, the respective slit nozzles 52 blow off clean air in such a manner as to generate mutually inward flow. The blowoff direction of each of the slit nozzles 52 is variable by a flexible ball joint. The “variable” condition herein refers to a condition that the angle of the blowoff port is variable. By this structure, the air blowoff direction can be easily varied when desired to be changed according to the purpose of use, for example.

As illustrated in FIGS. 1, 2, and 3B, each of the four vertical air supply port units 29 is provided at the corresponding corner of the four vertical corners formed by the four peripheral walls 26b. Each of the vertical air supply port units 29 includes a vertical manifold (air manifold) 53 connected with the corresponding individual flow path 39, and a plurality of slit nozzles 54 communicating with the vertical manifold 53. That is, one end (upstream end) of each of the vertical air supply port units 29 communicates with the air supply mechanism 27, and the other end (downstream end) is opened into the chamber 26.

The vertical manifold 53 is an air manifold which extends in the vertical direction along the vertical corner. The plural slit nozzles 54 are provided in line in the extending direction of the vertical manifold 53 (vertical direction) in such a condition that each of the slit nozzles 54 communicates with the horizontal manifold 53. Each of the slit nozzles 54 has a slit-shaped blowoff port having a blowoff direction extending obliquely downward and following the circumferential direction of the chamber 26 around the vertical axis corresponding to the center of the chamber 26. Thus, the respective slit nozzles 54 blow off clean air in such a manner as to generate rotational flow around the vertical axis within the chamber 26.

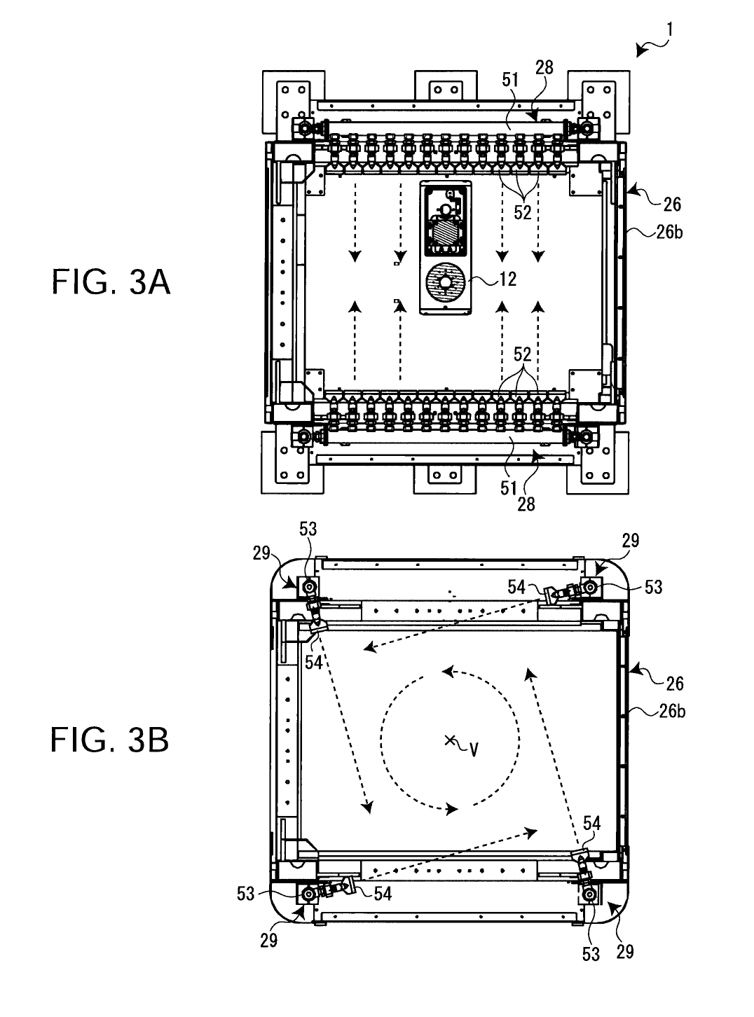

More specifically, the respective slit nozzles 54 are provided in such a condition that the blowoff direction of each of the slit nozzles 54 forms an angle allowing deviation of the blowoff direction from a vertical center axis V (vertical axis) corresponding to the center of the chamber 26 in the horizontal direction (see FIG. 3B). This angle generates optimum rotational flow, and is preferably set at an angle of larger than 0 degree and within the angle following the inner surfaces of the side walls when a virtual line passing the vertical center axis V (center of the chamber 26) has an angle of 0 degree.

As illustrated in FIGS. 1 and 2, the air exhaust mechanism 30 includes an exhaust port 61 disposed on the side wall of the lower external wall 5 and connecting the inside and the outside of the lower external wall 5 (the lower space 4), an exhaust filter 62 provided on the exhaust port 61 to clean air to be exhausted, and a fan unit 63 similarly provided on the exhaust port 61 to exhaust the air by overwhelming the resistance of the exhaust filter 62. The air exhaust mechanism 30 exhausts the air inside the chamber 26 and the air inside the lower space 4 to the outside through the exhaust port 61. The fan unit 63 is disposed inside the lower space 4 (upstream side) with respect to the exhaust filter 62.

While the chamber 26 in this embodiment has a rectangular parallelepiped shape, more particularly, a square pole shape, the shape of the chamber 26 may be a triangle pole shape, a pentagon pole shape, a hexagon pole shape, or other polygon pole shapes. The vertical air supply port units 29 (vertical manifolds 53) provided on the chamber 26 are only required at two vertical corners of the plural vertical corners.

As illustrated in FIGS. 1 and 2, the controller 13 has a robot controller for controlling the industrial robot 12. The controller 13 has a cooling fan unit 64 for supplying air to a heat generating portion of the controller 13 to cool the heat generating portion. The air supply direction of the cooling fan unit 64 is equalized with the air intake direction of the air exhaust mechanism 30 such that the flow of air generated by the cooling fan unit 64 can be smoothly discharged.

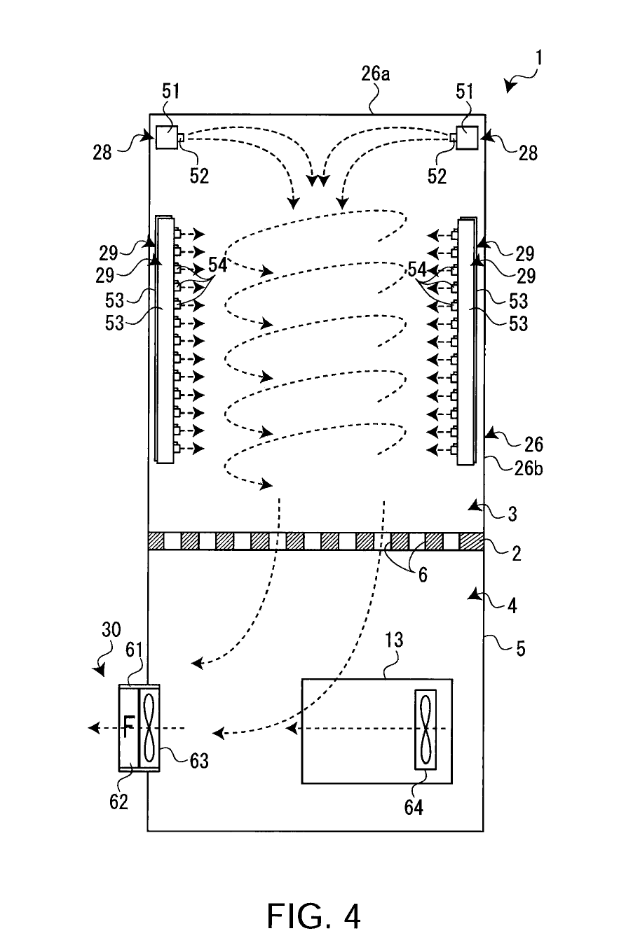

The flow of air within the robot cell 1 is now explained with reference to FIG. 4. This flow of air is produced by actuating the chamber facility 11 during operation of the industrial robot 12. As illustrated in FIG. 4, predetermined flow of air (airflow) is formed within the chamber 26 by simultaneously supplying air from the respective slit nozzles 52 of the two horizontal air supply port units 28 and from the respective slit nozzles 54 of the four vertical air supply port units 29. More specifically, the respective slit nozzles 52 of the two horizontal air supply port units 28 blow off clean air in such a manner as to generate mutually inward flow. As a result, a part of the clean air reaches the top surface of the chamber 26, and other supplied clean air collides with each other in the vicinity of the top wall 26a of the chamber 26. Since the air exhaust mechanism 30 is disposed at the lower position of the chamber 26, the supplied air smoothly moves downward after collision and generates downflow.

The respective slit nozzles 54 of the four vertical air supply port units 29 blow off clean air in such a manner as to generate rotational flow around the vertical axis. As a result, rotational flow around the vertical axis is produced within the chamber 26 in the area other than the vicinity of the top wall 26a. Since the air exhaust mechanism 30 is disposed at the lower position of the chamber 26, the supplied air moves downward while rotating and forms rotational downflow.

The air having reached the support plate 2 by the predetermined flow of air thus formed is introduced into the lower space 4 through the communicating holes 6. The air within the lower space 4 is exhausted through the exhaust port 61 by the function of the air exhaust mechanism 30. During operation of the industrial robot 12, therefore, clean air is kept supplied and exhausted to and from the chamber 26 to ventilate the chamber 26 by utilizing the predetermined airflow.

According to the structure including the vertical air supply port units 29 each of which has the vertical manifold 53 and the plural slit nozzles 54, air can be uniformly blown off from the plural slit nozzles 54, and thus preferable rotational flow can be generated. In addition, the structure of the respective vertical air supply port units 29 can be simplified.

Moreover, the arrangement of the plural slit nozzles 54 in line in the vertical direction allows the rotational flow to be generated in the entire area in the vertical direction. Thus, no air staying space is further produced. In addition, appropriate downflow can be produced without requiring an air supply port section on the top wall 26a.

Furthermore, according to the structure which includes the slit nozzles 54 whose blowoff directions are variable, the blowoff directions of the respective slit nozzles 54 can be controlled. Thus, appropriate rotational flow satisfying various requirements can be produced.

While the blowoff directions of the respective slit nozzles 54 are obliquely downward directions to promote downflow in this embodiment, the blowoff directions of the slit nozzles 54 may be the horizontal direction instead of the obliquely downward direction.

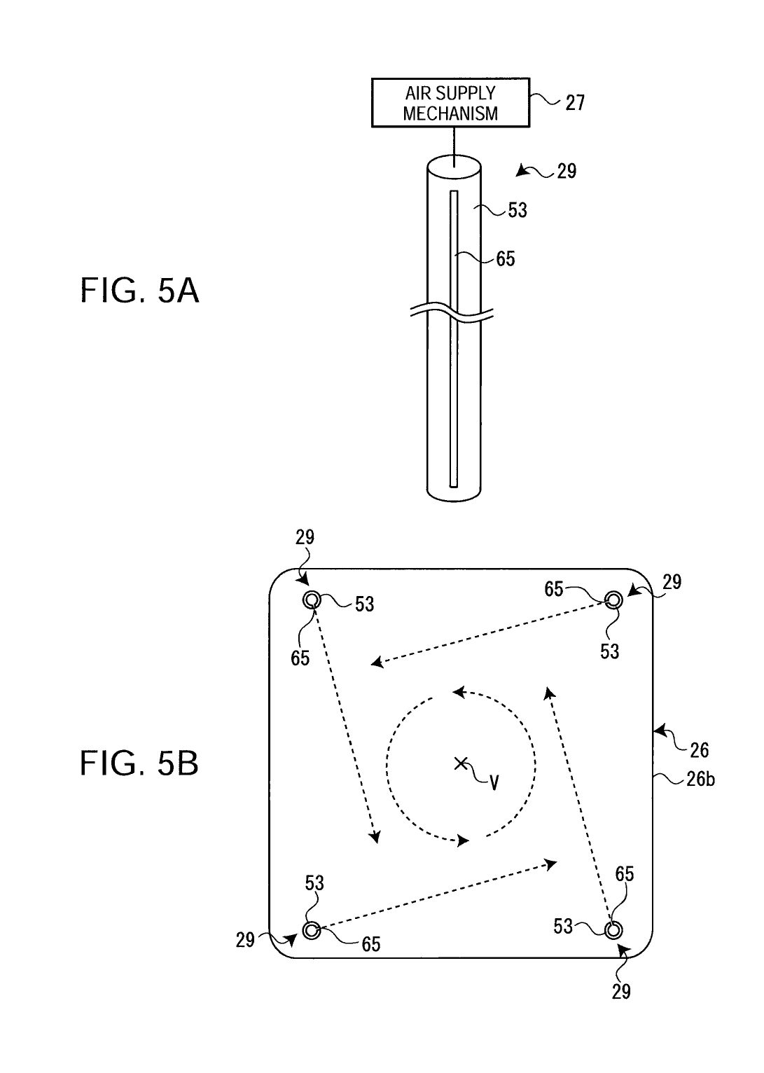

A modified example of the vertical air supply port units 29 is now explained with reference to FIGS. 5A and 5B. As illustrated in FIGS. 5A and 5B, each of the vertical air supply port units 29 according to this modified example includes the cylindrical vertical manifold 53 having closed front and rear ends, and a slit hole (slit shaped blowoff hole) 65 provided on the vertical manifold 53 and extending in the vertical direction (see FIG. 5A). The slit hole 65 is formed in a direction following the circumferential direction of the chamber 26 around the vertical axis corresponding to the center of the chamber 26, and clean air is blown off through the slit hole 65 in the direction following the circumferential direction around the vertical axis (see FIG. 5B). Thus, clean air is blown off through the slit hole 65 in such a manner as to generate rotational flow around the vertical axis within the chamber 26.

According to the vertical air supply port units 29 each of which has the vertical manifold 53 and the slit hole 65, the structure of the vertical air supply port units 29 can be simplified, and the rotational flow can be generated throughout the area in the vertical direction by using the air uniformly blown off. Thus, no air staying space is further produced.

According to this structure, the rotational flow around the vertical axis is generated within the chamber 26, and the air is exhausted from the lower position of the chamber 26. Thus, the air within the chamber 26 moves downward while rotating around the vertical axis, thereby producing rotational downflow. As a result, the air flows throughout the chamber 26, and no air staying space is produced. In addition, dust generated within the chamber 26 is removed toward below. Accordingly, a high degree of air cleanliness can be maintained within the chamber 26. Moreover, since the downflow can be produced by the structure not necessarily requiring an air supply port section on the top wall 26a area (the ceiling area), an unoccupied space can be secured in the top wall 26a area.

According to the rectangular parallelepiped chamber 26 which has the vertical air supply port units 29 at the vertical corners formed by the four peripheral walls 26b, an unoccupied space can also be secured in the area of the four peripheral walls 26b. In addition, since air is blown off from the vertical corners where air easily stays, no air staying space is further produced.

According to the structure which includes the exhaust filter 62, air containing contaminants (dust) within the chamber 26 and the lower space 4 is cleaned, and thus clean air is exhausted to the outside. Thus, the outside atmosphere is not contaminated by the air exhausted from the chamber facility 11 (the robot cell 1). In addition, the air around the air exhaust mechanism 30 where dust and the like are easily produced can be ventilated.

While the chamber facility 11 according to this embodiment of the invention is applied to the robot cell 1 which uses the suspension type industrial robot 12, the chamber facility 11 may be applied to other various types of manufacturing devices and the like. In addition, the technology according to this embodiment of the invention having been applied to the chamber 26 which has the flat top wall 26a is also applicable to the chamber 26 which does not have the air supply port section on the top wall 26a due to the shape of the top wall area.

While the vertical air supply port unit 29 is provided at each of the four vertical corners in this embodiment, the vertical air supply port unit 29 may be equipped only at two vertical corners of the four vertical corners. For example, two units of the vertical air supply port unit 29 may be provided at the diagonally positioned vertical corners.

While the vertical air supply port units 29 are provided at the vertical corners of the chamber 26 in this embodiment, the vertical air supply port units 29 may be disposed at the central portions of the four peripheral walls 26b with respect to the vertical corners.

The entire disclosure of Japanese Patent Application No. 2009-146053, filed Jun. 19, 2009 and 2010-065803, filed Mar. 23, 2010 are expressly incorporated by reference herein.

What is claimed is:

1. A chamber facility, comprising:
an air supply unit which supplies clean air to the inside of a chamber;
an air supply port section which has one end communicating with the air supply unit and the other end opened into the chamber; and
an air exhaust unit which exhausts air within the chamber from an exhaust port formed at a lower position of the chamber,
wherein the air supply port section has a plurality of air supply port units which generate rotational flow around a vertical axis within the chamber.

2. The chamber facility according to claim 1, wherein each of the air supply port units includes an air manifold communicating with the air supply unit, and a plurality of blowoff ports communicating with the air manifold.

3. The chamber facility according to claim 2, wherein:
the air manifold extends in the vertical direction; and
the plural blowoff ports are disposed in line in the vertical direction along the air manifold.

4. The chamber facility according to claim 2, wherein each of the blowoff ports can vary the direction of blowing off clean air.

5. The chamber facility according to claim 1, wherein each of the air supply port units includes an air manifold communicating with the air supply unit, and a slit-shaped blowoff port communicating with the air manifold.

6. The chamber facility according to claim 1, wherein:
the chamber has a rectangular parallelepiped shape; and
the plural air supply port units are at least the two air supply port units disposed at least at two diagonally positioned vertical corners included in four vertical corners formed by peripheral side walls of the chamber.

7. The chamber facility according to claim 1, wherein the air exhaust unit is disposed in a lower space immediately below a floor portion of the chamber and exhausts air within the chamber and within the lower space via an exhaust filter which removes a contaminant contained in the air.

8. A chamber ventilating method which ventilates the inside of a chamber by supplying and exhausting clean air to and from the chamber, comprising:
generating rotational flow within the chamber by supplying the clean air from the side of the chamber while exhausting the air from a lower position of the chamber.

9. A chamber facility, comprising:
an air supply unit which supplies air to the inside of a chamber having a polygon pole shape surrounded by a top wall, a bottom wall, and a plurality of side walls;
an air supply section which has one end communicating with the air supply unit and the other end communicating with the chamber; and
an air exhaust unit which exhausts air within the chamber from an exhaust port formed on the bottom wall of the chamber, wherein
the air supply section has air units which are disposed at least at two corners included in plural corners formed by the plural side walls of the chamber and extend in the vertical direction, and
each of the air units has a blowoff port whose blowoff direction shifts from a vertical axis of the chamber at an angle of larger than 0 degree.

10. The chamber facility according to claim 10, wherein:
each of the air units has a plurality of blowoff ports; and
the plural blowoff ports are disposed in line at equal intervals in the vertical direction.

11. The chamber facility according to claim. 10, wherein each of the air units has a slit-shaped blowoff port extending in the vertical direction.
